(19) United States
(12) Patent Application Publication
(10) Pub. No.: US 2025/0225436 A1
(43) Pub. Date: Jul. 10, 2025

(54) METHODS AND APPARATUS FOR ENHANCING 3GPP SYSTEMS TO SUPPORT FEDERATED LEARNING APPLICATION INTERMEDIATE MODEL PRIVACY VIOLATION DETECTION

(71) Applicant: InterDigital Patent Holdings, Inc., Wilmington, DE (US)

(72) Inventors: Zhibi Wang, Woodridge, IL (US); Alec Brusilovsky, Downingtown, PA (US); Achref Methenni, Montreal (CA); Morteza Kheirkhah, London (GB); Ulises Olvera-Hernandez, Saint-Lazare (CA)

(21) Appl. No.: 18/850,959

(22) PCT Filed: Mar. 23, 2023
(86) PCT No.: PCT/US2023/016115

§ 371 Date: Sep. 25, 2024

Related U.S. Application Data
(60) Provisional application No. 63/324,435, filed on Mar. 28, 2022.
(60) Provisional application No. 63/436,790, filed on Jan. 3, 2023.

(51) Int. Cl. G06N 20/00; H04L 41/16; H04W 12/02; H04W 64/00

(52) U.S. Cl. CPC G06N 20/00; H04L 41/16; H04W 12/02; H04W 64/00

(57) ABSTRACT

Methods, protocols, systems and apparatus for the detection of violations of privacy rules for intermediate models in federated learning applications are described. One method may include receiving, from a network entity, a federated learning intermediate model, training the federated learning intermediate model using a training data set unique to the WTRU to generate a trained federated learning intermediate model, and determining, based on one more rules associated with a location of the WTRU, whether any one or more of the trained federated learning intermediate model and the training data set indicate one or more privacy violations. Based on whether any one or more of the trained federated learning intermediate model and the training data set indicate one or more privacy violations, the method may include transmitting a message or information to the network entity.

### CROSS-REFERENCE TO RELATED APPLICATIONS

This application claims the benefit of U.S. Patent Application No. 63/324,435 filed Mar. 28, 2022 and U.S. Patent Application No. 63/436,790 filed Jan. 3, 2023. The contents of these earlier filed applications are incorporated herein by reference in their entirety for all purposes.

### FIELD

This disclosure may generally pertain to methods, systems and/or apparatus for enhancing 3GPP systems. For example, some example embodiments may relate to methods, protocols, apparatus and/or systems to detect violations of privacy rules for intermediate or initial models in federated learning applications.

### BACKGROUND

Machine learning (ML) may be considered an area of artificial intelligence (AI), in which algorithms build a model based on training data to make predictions without being specifically programmed to do so. Federated learning (FL) may refer to a ML technique that trains an algorithm across multiple decentralized servers or edge devices which have local data samples that are not shared.

### SUMMARY

An embodiment may be directed to a method implemented in a Wireless Transmit Receive Unit (WTRU). The method may include receiving, from a network entity, a federated learning intermediate model or federated learning initial model, training the federated learning intermediate model (or initial model) using a training data set unique to the WTRU to generate a trained federated learning intermediate model (or initial model), and determining, based on one more rules associated with a location of the WTRU, whether any one or more of the trained federated learning intermediate model and the training data set indicate one or more privacy violations. Based on whether any one or more of the trained federated learning intermediate model and the training data set indicate one or more privacy violations, the method may include transmitting a message or information to the network entity.

An embodiment may be directed to a wireless transmit/receive unit (WTRU) comprising circuitry that may include at least one of a transmitter, receiver, processor and/or memory, which may be configured to: receive, from a network entity, a federated learning intermediate model, train the federated learning intermediate model using a training data set unique to the WTRU to generate a trained federated learning intermediate model, and determine based on one more rules associated with a location of the WTRU, whether any one or more of the trained federated learning intermediate model and the training data set indicate one or more privacy violations. Based on whether any one or more of the trained federated learning intermediate model and the training data set indicate one or more privacy violations, the WTRU may be configured to transmit a message to the network entity.

An embodiment may be directed to a method that may be implemented in or by a network entity or node. The method may include receiving a federated learning model from an application server or other entity, determining whether the federated learning model indicates one or more privacy violations and, based on whether the federated learning model indicates one or more privacy violations, transmitting a message to a plurality of WTRUs or to the application server.

An embodiment may be directed to a network element or node that includes circuitry, which may include one or more of a transmitter, receiver, processor and/or memory, configured to: receive a federated learning model from an application server or other entity, determine whether the federated learning model indicates one or more privacy violations and based on whether the federated learning model indicates one or more privacy violations, transmit a message to a plurality of WTRUs or to the application server.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGS.”) indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a signal flow diagram illustrating intermediate model privacy violation detection flow for FL in accordance with an exemplary embodiment;

FIG. 3 is a signal flow diagram illustrating the interactions between the client-side privacy violation engine 201 and the network-side privacy violation engine 203 of step 6 of FIG. 2 in greater detail in accordance with an embodiment;

FIG. 4 illustrates an example flow diagram of a method, according to one embodiment; and

FIG. 5 illustrates an example flow diagram of a method, according to one embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly and/or inherently (collectively “provided”) herein.

### Example Communication Systems

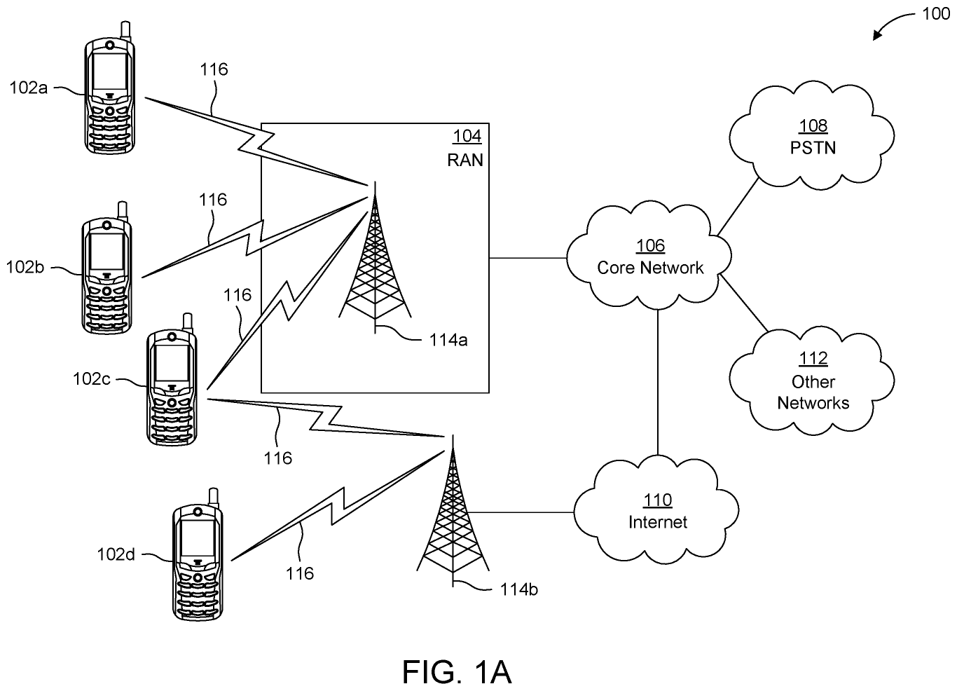

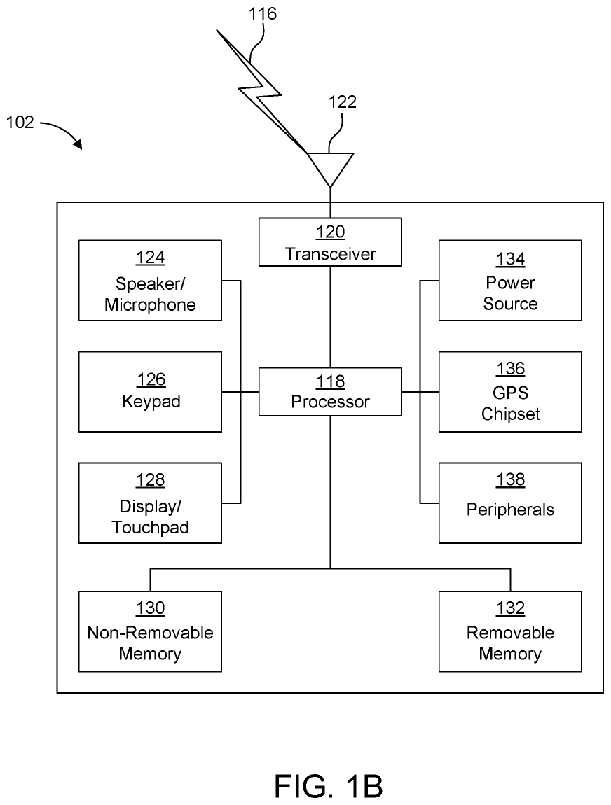

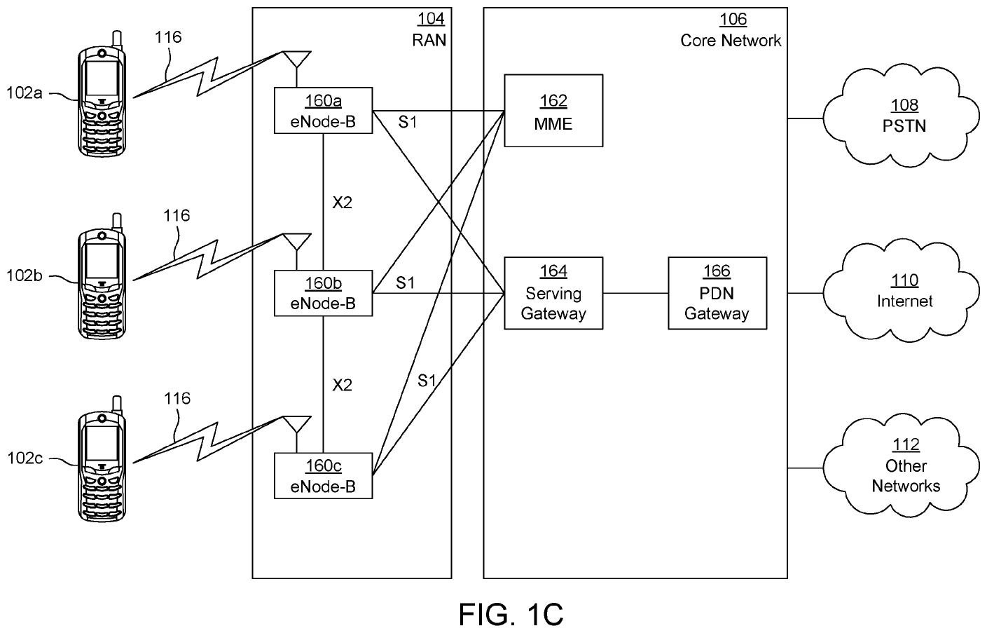

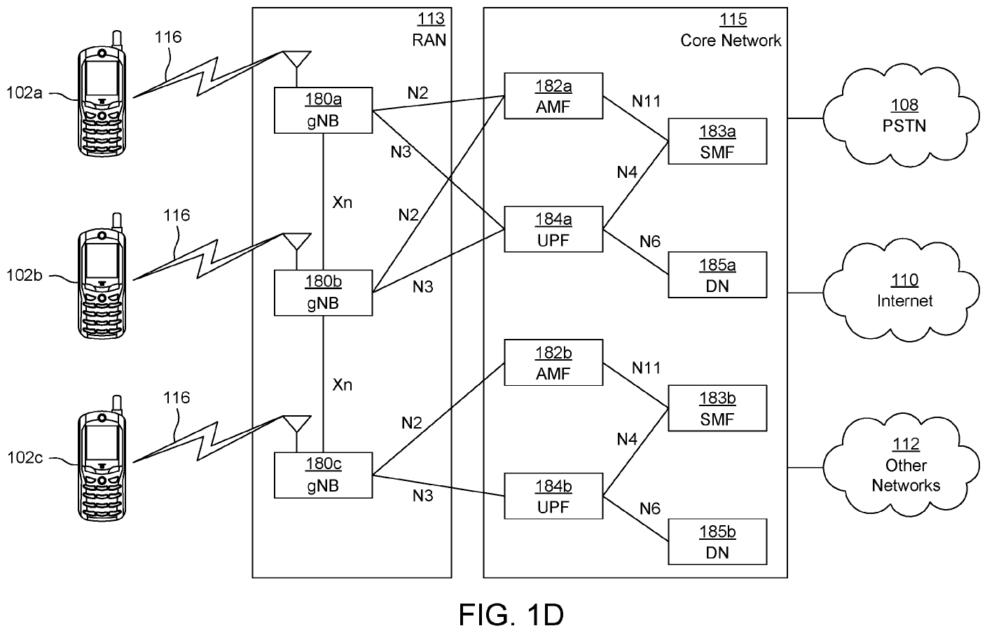

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the uplink (UL) and/or downlink (DL), support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different Packet Data Unit (PDU) sessions with different requirements), selecting a particular SMF 183a, 183b, management of the registration area, termination of Non-Access Stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF a82a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Representative Procedures for Implementing Privacy in Federated Learning

Federated Learning (FL) enables multiple participants (e.g., multiple WTRUs) to construct an Artificial Intelligent Machine Learning (AIML) learning model without sharing their private training data with each other. For example, multiple WTRUs can jointly train a WTRU-based application without revealing the individual participant's interactions. Federated models are then created by aggregating model updates submitted by the participants. To protect confidentiality of the training data, the Application Server (AS), by design, has no visibility into how these updates are generated.

Federated learning is vulnerable to privacy attacks, such as model extraction or inference attacks, whereby model updates can leak information about the participants' training data to adversarial participants.

A membership inference attack is an inference attack to infer training data details that illicitly obtains information by checking if certain data exists in a training set. The attacker misuses the global model to obtain information on the training data of the other users. In such cases, the information on the training data set is inferred through guesswork and training the predictive model to predict original training data.

Unintentional data leakage and reconstruction through inference is a scenario where updates or gradients from clients leak unintended information at the central server. Malicious/curious clients can use the global model and parameters to reconstruct the training data of other clients.

In a Federated Learning training model, an AS selects a set of WTRUs/devices to participate in a distributed training session. A training session may include several training cycles. For each cycle, the selected WTRU receives the intermediate model from the server, trains it with the WTRU environmental attributes, and then submits the trained intermediate model back to the application server. The application server may then aggregate all the intermediate models received from all WTRUs and produce the new model for the next cycle of FL.

Therefore, when participating WTRUs submit the intermediate trained model to the application server, the trained model has to be scrutinized to avoid potential privacy violation(s).

Federated learning introduces potentially more serious threats than regular AIML because federated learning clients can access the intermediate models it receives and submit updates to be aggregated into the global model as part of the federated learning process, whereas regular/non-FL AIML clients previously acted only as passive data providers. The intermediate model received from the Application Server (AS) and the trained model can contain privacy information that may violate privacy law(s) or regulation(s).

Example embodiments described herein provide methods, apparatus, systems, and techniques for detecting privacy violation in an intermediate model received by a WTRU that participates in FL, dynamically evaluating a privacy violation integrated in the intermediate model submitted by a WTRU that participated in FL, and/or utilizing AIML and privacy regulations, laws, and privacy policies to evaluate and scrutinize FL intermediate models.

In accordance with some embodiments, an intermediate FL model received and submitted by a participating WTRU may be dynamically evaluated to assure that there is no potential privacy violation to the merged AIML model when integrating the intermediate model into it. The data used to perform the privacy assessment may come from the intermediate model received by the FL client, the trained model that is submitted by the WTRU, and/or the training data.

In an example embodiment, the privacy violation detection may be performed before the WTRU receives the intermediate model to start the next round of FL training and, again, as soon as the WTRU submits the trained intermediate model back to the application server. The client privacy engine may continuously be working on the training dataset when it is ready to be trained, for example.

In some example embodiments, the privacy violation and the threat detection to the intermediate model may be carried out in parallel.

In accordance with an embodiment, privacy analytic engines may be, although not necessarily, placed at both the WTRU side and the network side. According to one embodiment, the privacy analytics engine(s) may perform one or more of the following tasks:
1. The intermediate model trained by the WTRU may be privacy violation detected for potential privacy violations, assisted by the AI engine, privacy policy and regulations. This detection may be performed as a collaboration between the client-side privacy engine and the network-side privacy engine.
2. The WTRU training dataset and the trained intermediate model may be used as inputs to the client-side privacy engine, which may perform the privacy violation detection with dynamic policies and inputs from the network using a white box approach, for example. In an embodiment, the network may optionally request and/or receive, from the WTRU, its location and may send the associated privacy laws, regulations and/or rules to the WTRU (e.g., to the client-side privacy engine), which may be based on the WTRU's location, to be used for detection of possible privacy violations. To save memory and to help detect any privacy violation as early as possible, the training dataset may be filtered and scrutinized continuously as the dataset is available before it is used to train the model.
3. The network-side privacy engine may perform privacy violation detection on the source intermediate models that are to be sent to WTRUs and/or may perform privacy violation detection on the trained intermediate models trained by and returned to the AS by the WTRUs.
4. The inputs to the network-side privacy engine may include the intermediate models, privacy policies, laws, and/or regulations. For example, these may be input using a black box approach. Additionally, the WTRU may provide some trusted samples (e.g., a small testing dataset) to the network-side privacy engine so that it can verify the intermediate model in cases such as reenforced learning, for example. The samples from WTRUs that are reflected in the AIML training model may be collected and/or sent to the network-side privacy engine along with the trained intermediate models.
5. Helped by advanced AIML algorithms, such as reenforced learning or supervised learning and more powerful computational resources, the network-side privacy engine may detect privacy violations in both the training model (sent from the network to the WTRU) as well as in the trained model (returned to the network from the WTRU that is supposed to be integrated into the global mode). The network-side privacy engine can dynamically feed back to the client-side privacy engine privacy violation detection based on its detection results, for example.

It is noted that a “white box approach” as discussed herein may refer to a method in which the privacy engine (e.g., client-side privacy engine) knows the inputs, e.g., the training vectors, for the ML training. A “block box approach” as discussed herein may refer to a method in which the privacy engine (e.g., network-side privacy engine) only has the trained model without knowing the inputs or training vectors.

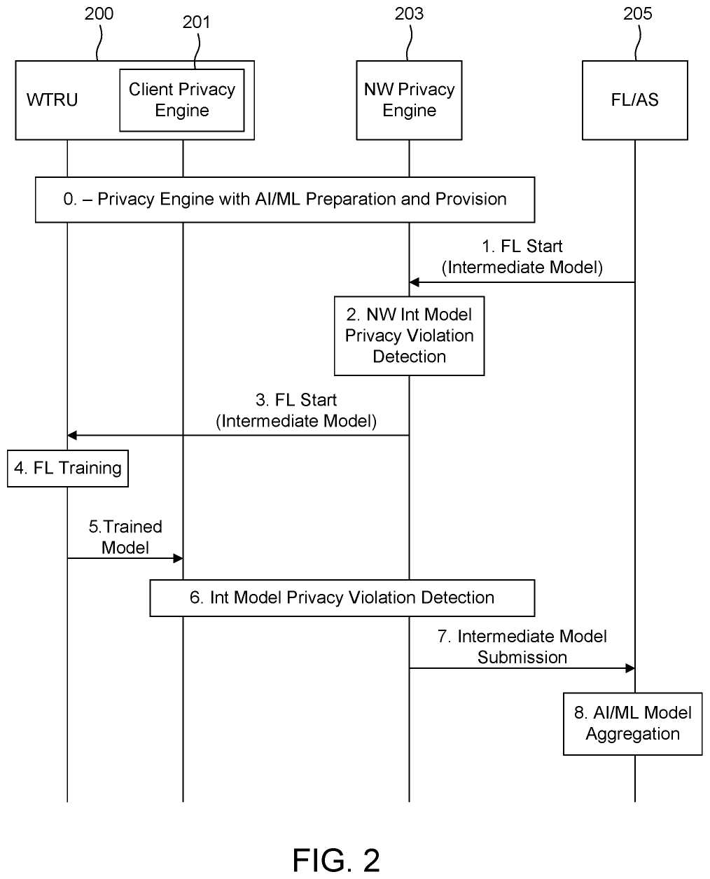

FIG. 2 is a signal flow diagram illustrating intermediate model privacy violation detection flow for FL, in accordance with an example embodiment. It is noted that FIG. 2 illustrates one example of privacy violation detection, and modifications or changes to the flow of FIG. 2 are contemplated according to other embodiments or examples described elsewhere herein.

In step 0, the WTRU-side privacy violation engine 201 at the WTRU 200 and network-side privacy violation detection engine 203 are prepared and provisioned for FL. AIML may be used in the privacy violating detection engine. However, this is not illustrated in FIG. 2 as it may be assumed that such training has been performed previously.

In step 1, the federated learning application server sends an intermediate AIML model to the WTRUs (e.g., WTRU 200) that has been selected as the FL candidate for the next round of FL.

In step 2, the network-side privacy violation engine 203 evaluates the intermediate model for a potential privacy violation before it sends it to the selected WTRU(s) 200 for FL.

Although not shown in FIG. 2, if such violations are detected, the network-side privacy violation engine may reject the intermediate model and may inform the AS that the intermediate model may have (e.g., may contain or indicate) privacy violations. If the AS receives the rejection from the privacy violation detection engine 203, the AS may choose to roll back to the previous aggregate model that passed the test and use that previous model with a different set of participants/WTRUs to generate a new aggregate model that might pass the privacy violation screening.

In certain embodiments, the network-side privacy violation detection engine 203 may handle: signaling traffic to be able to communicate with the AS and network entities and WTRU, and/or user plane traffic that is the intermediate model for FL provided by the AS.

In one embodiment, the network-side privacy engine may have its functionality split into a signaling part and a user plane part. The signaling functionality may communicate with a user plane level function, which can be collocated or close to the serving User Plane Function (UPF) for the corresponding WTRU. Since the user plane traffic is in the path between the WTRU and the UPF, the UP functionality is able to perform the black box violation detection with ease.

Returning to FIG. 2, if, on the other hand, in step 2, no privacy violation is detected, then, in step 3, the network-side privacy violation engine sends the intermediate model to the candidate WTRUs for FL.

Next, in step 4, the WTRU client starts the FL training using the received intermediate model.

Next, in step 5, the client-side privacy engine 201 receives the finished training model from the WTRU.

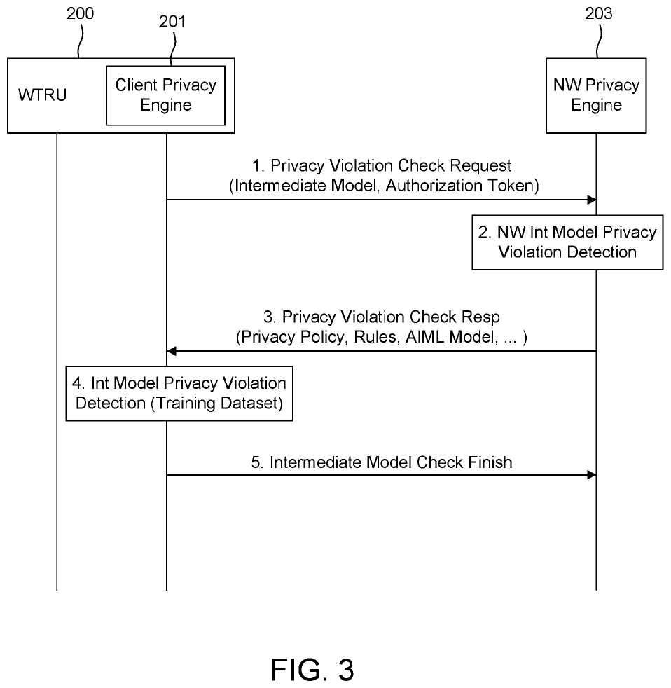

In step 6, after the AIML client finishes the FL training, the client-side privacy violation detection engine 201 collaborates with the network-side privacy engine 203 to detect any privacy violation in the training dataset that was used for FL training, as well as the trained intermediate model. For example, in some embodiments, the network-side privacy engine 203 may request and/or receive the location of the WTRU 200 so that it can send to the WTRU the privacy laws, regulations and/or rules associated with the WTRU's jurisdictional (e.g., geographical) location. The details of step 6 are shown in FIG. 3 and will be expounded upon in more detail in connection with that FIG.

Assuming that no privacy violation was detected in step 6, then, in step 7, the finished intermediate model is sent to the AS 205.

Otherwise, the network-side privacy engine 203 may send a rejection message to the AS 205 with an error code indicating that the trained intermediate model has (e.g., includes or indicates) privacy violations (not shown in FIG. 2). As discussed further below, the privacy violation detection results may be used for the WTRU selection of the next FL cycle.

Finally, in step 8, the AS 205 collects all the intermediate models from all WTRUs participating in this FL session and aggregates them into the global model (or another intermediate model for the next round of FL training).

As mentioned above, FIG. 3 is a signal flow diagram illustrating the interactions between the client-side privacy violation engine 201 and the network-side privacy violation engine 203 of step 6 of FIG. 2 in greater detail. It is noted that FIG. 3 illustrates one example according to certain embodiments, but that modifications or changes to the flow of FIG. 3 are contemplated according to other embodiments or examples described elsewhere herein.

In step 1, after the AIML client finishes the FL training, the client privacy engine in the WTRU 201 requests the network-side privacy violation engine 203 to start the privacy violation detection with the trained intermediate model and an authorization token. The authorization token is used by the AS for the WTRU FL training authorization when the WTRU is selected to participate in the FL. When the network-side privacy violation engine receives the authorization token, it may first validate the token, for example, before starting the process on the trained intermediate model from the WTRU.

In step 2, the network-side privacy violation engine 203 uses the trained model along with privacy policy, rules, and/or regulations, to perform the privacy violation detection. The network-side privacy violation detection may be performed using a black box algorithm without training data from the WTRUs to preserve the privacy of the WTRU training data. Helped by a more powerful computational capability from the network and advanced AIML algorithms, the engine 203 can detect advanced privacy violation or threats as compared with the resource-limited client-side privacy engine 201.

The network-side privacy engine 203 may handle the privacy violation detection for the trained model to be sent back to the AS by the WTRU, for example, including: signaling traffic to be able to communicate with the AS, network entities, and the WTRU, and/or user plane traffic that is the intermediate model for FL provided by the AS.

In one embodiment, the network privacy engine may have the functionality split into a signaling part and a user plan part. The signaling functionality communicates with a user plane level function, which can be collocated or close to the serving UPF for the corresponding WTRU. Since the user plane traffic is in the path between the WTRU and the UPF, the UP functionality is able to perform the black box violation detection with ease.

In step 3, the network-side privacy engine 203 sends to the client-side privacy violation engine 201 additional information, e.g., one or more privacy regulations, privacy laws, updated privacy policy or policies, and/or the AIML model to be used by the client privacy engine, etc. For example, in an embodiment, the network-side privacy violation engine 203 may optionally request and/or receive, from the WTRU 200, the location of the WTRU 200. Based on the location of the WTRU 200, the network-side privacy violation engine 203 may send, at step 3, the appropriate privacy laws, regulations and/or rules to the WTRU 200 (e.g., to the client-side privacy engine 201) to be used for detection of possible privacy violations. Hence, the WTRU 200 may be made aware of the appropriate privacy laws, regulations and/or rules that are currently applicable based on the location of the WTRU 200. The information (e.g., only the information) that is updated as a result of the outcome of the network privacy engine violation detection is sent.

In step 4, the client-side privacy violation engine 201 then uses the training dataset, and the information received from the network-side privacy violation engine 203 to perform the privacy violation detection on the training dataset and trained model with a white box approach. Since the training dataset was privacy violation detected when it was generated, this step performs (e.g., only performs) the detection on the trained model with preconfigured information and updated parameters received in step 3 above.

Finally, in step 5, the client-side privacy violation engine 201 sends a privacy violation check finish message to the network-side privacy violation engine 203. If the trained intermediate model contains (e.g., indicates or includes) any privacy violations, the client-side privacy violation engine 201 should reject the model by sending a rejection message to the network-side privacy violation engine and not sending the intermediate model to the AS. In such a case, the AS may decide not to choose that WTRU in a future round of FL cycles.

If, on the other hand, the trained intermediate model does not contain (e.g., does not indicate or does not include) any privacy violations, the client-side privacy violation engine should send an approval message, the approval message including the trained federated learning intermediate learning model.

If both client and network privacy violation detection finish without detecting a privacy violation, the network-side privacy violation engine 203 may forward the intermediate model to the AS.

In accordance with some example embodiments, the methods, systems, apparatus, and techniques disclosed herein may be embodied within the 3GPP network functionalities, for example, by mapping the client-side privacy violation engine, network-side privacy violation engine, messages and routing mechanism, etc. to 3GPP network functionalities. In an embodiment, the AS may request analytics from the Network Data Analytics Function (NWDAF) (or via NEF), e.g., the specific UPF, Data Network Access Identifier (DNAI), Single Network Slice Selection Assistance Information (S-NSSAI) or even WTRU ID/group ID. The client privacy engine and network privacy engine may each sub-functionalities of the NWDAF, and they may communicate with each other via Service Based Architecture (SBA) Interface (SBI). For example, in some embodiments, the private policies and private regulations may be from the Policy Control Function (PCF), and the settings and configurations may be from the Unified Data Repository (UDR).

3GPP defines a Service-Based Architecture (SBA), where the control plane functionality and common data repositories of a 5G network are delivered by way of a set of interconnected Network Functions (NFs), each with authorization to access each other's services. In an embodiment, 3GPP SBA may be extended from the Core Network into the client-side privacy violation engine 201 and network-side privacy violation engine 203, which may be represented by SBA functions. In such an embodiment, the client-side privacy violation engine 201 and network-side privacy violation engine 203 may interact over the SBA bus. For example, the signaling represented by steps 1, 3, and 5 of FIG. 2 may be carried via the SBA bus.

For example, the network privacy violation detection engine may handle: signalling traffic for communicating with the AS, network entities, and WTRU; and/or user plane traffic, which includes the intermediate model for FL provided by the AS.

In such an embodiment, the network-side privacy violation engine may have the functionality split into a signalling part and a user plane part. The signalling functionality may communicate with a user plane level function, which can be collocated or close to the serving UPF for the corresponding WTRU. Since the user plane traffic is in the path between the WTRU and the UPF, the UP functionality is able to perform the black box violation detection with ease.

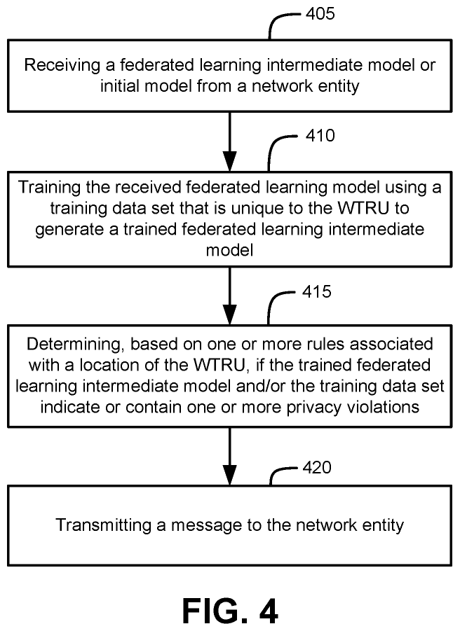

FIG. 4 illustrates an example flow diagram of a method for the detection of violations of privacy rules or regulations in federated learning model(s), according to some example embodiments. In certain embodiments, the method of FIG. 4 may be performed by or implemented in a WTRU (e.g., the WTRU depicted in FIG. 2 and/or FIG. 3). In other example embodiments, the method of FIG. 4 may be performed by one or more other network element(s) or network entities, for example.

As illustrated in the example of FIG. 4, the method may include, at 405, receiving a federated learning intermediate model, or initial model, from a network entity. For example, in an example embodiment, the network entity may be or may include an AS or may be another 3GPP or core network node. As illustrated at 410, the method may include training the federated learning intermediate model using a training data set that is unique to the WTRU to generate a trained federated learning intermediate model.

As further illustrated in the example of FIG. 4, at 415, the method may include determining, based on one or more rules associated with a location of the WTRU, whether any one or more of: (i) the trained federated learning intermediate model and/or (ii) the training data set indicate or contain one or more privacy violations.

According to some embodiments, the one or more rules associated with the location of the WTRU may include at least one of privacy policies, privacy laws, and/or privacy regulations. In one embodiment, the rules associated with the location of the WTRU may be received from the network entity.

Based on whether any one or more of the trained federated learning intermediate model and/or the training data set indicate one or more privacy violations, the method may include, at 420, transmitting a message or information to the network entity.

In one embodiment, the determining 415 may include determining that any one or more of the trained federated learning intermediate model (or initial model) and/or the training data set do not contain or indicate one or more privacy violations. When it is determined that the trained federated learning intermediate model and/or the training data set do not indicate privacy violation(s), then the transmitted message or information may include or may indicate the trained federated learning intermediate (or initial) model. In other words, according to an embodiment, on a condition that it is determined that the trained federated learning intermediate model and/or the training data set do not contain or indicate privacy violation(s), then the transmitted message or information may include or indicate the trained federated learning (intermediate or initial) model.

In one embodiment, the determining 415 may include determining that any one or more of the trained federated learning intermediate model (or initial model) and/or the training data set indicate or include one or more privacy violations. When it is determined that the trained federated learning intermediate (or initial) model and/or the training data set do indicate or do contain privacy violation(s), then the transmitted message may include or may indicate that the trained federated learning intermediate model is rejected. In other words, according to an embodiment, on a condition that it is determined that the trained federated learning intermediate model and/or the training data set actually do contain or indicate privacy violation(s), then the transmitted message or information may indicate that the trained federated learning (intermediate or initial) model is rejected.

In a representative embodiment, the determining 415 of whether any one or more of the trained federated learning intermediate model and the training data set indicate one or more privacy violations may include: (i) transmitting a request to the network entity to perform privacy violation detection on the trained intermediate model, where the request includes or indicates an authorization token; (ii) receiving additional information from the network-side privacy violation engine, where the additional information includes or indicates at least one of a privacy regulation, a privacy law, an updated privacy policy, and/or an AIML model; and (iii) determining whether any one or more of the trained federated learning intermediate model and/or the training data set indicate one or more privacy violations based on the additional information.

In an example embodiment, the determining 415 may include determining, by a client-side privacy violation engine of the WTRU, whether any one or more of the trained federated learning intermediate model (or initial model) and/or the training data set indicate one or more privacy violations using a white box approach.

According to some embodiments, although not illustrated in the example of FIG. 4, the method may optionally include receiving, from the network entity, a request for the location of the WTRU, and sending the location of the WTRU to the network entity.

In an embodiment, the method may further include iteratively performing the receiving, training, determining, and transmitting steps until a training session for the federated learning intermediate model is complete.

It should be noted that FIG. 4 is provided as one example according to some embodiments. However, the steps depicted in FIG. 4 should not be construed as being mandatory for implementing example embodiments. For example, it should be understood that the method of FIG. 4 may be modified according to, or combined with, other examples or embodiments described elsewhere herein.

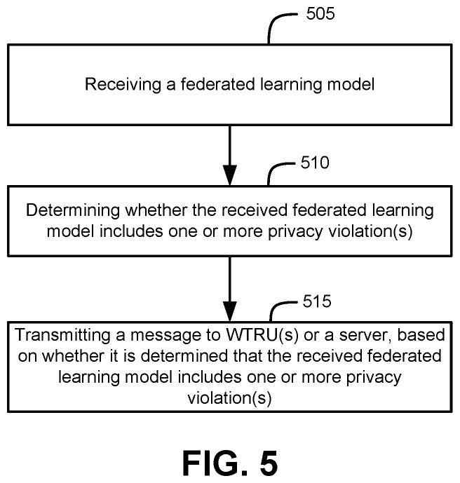

FIG. 5 illustrates an example flow diagram of a method for detecting violations of privacy rules or regulations, for example, in federated learning model(s), according to some example embodiments. In certain embodiments, the method of FIG. 5 may be performed by or implemented in a network entity or network node. For example, in an embodiment, the method of FIG. 5 may be performed by a network (NW)-side privacy engine and/or AS, as illustrated in the examples of FIG. 2 or FIG. 3. It should be noted that the NW-side privacy engine may be implemented in various network components or entities. In other example embodiments, the method of FIG. 5 may be performed by other network element(s) or network entity/entities, e.g., 3GPP or core network nodes, for example.

As illustrated in the example of FIG. 5, the method may include, at 505, receiving a federated learning model. For instance, in one embodiment, the federated learning model may be received from an application server or other similar entity or server. In an embodiment, the method of FIG. 5 may include, at 510, determining whether the federated learning model includes, contains and/or indicates one or more privacy violations.

Based on whether the federated learning model indicates one or more privacy violations, the method may include, as shown at 515, transmitting a message or information to a plurality of WTRUs or to the application server. For example, in one embodiment, the determining 510 may include, or result in, determining that the federated learning model does not indicate one or more privacy violations and, in this case, the transmitting 515 may include transmitting the message which includes or indicates the federated learning model to the plurality of WTRUs. In another embodiment, the determining 510 may include, or result in, determining that the federated learning model indicates or contains one or more privacy violations and, in this case, the transmitting 515 may include transmitting, e.g., to the application server, the message which may include or indicate that the federated learning model includes or indicates privacy violations.

In some embodiments, the method may optionally include receiving trained federated learning models from the plurality of WTRUs and aggregating the trained federated learning models to produce a new federated learning model.

According to an embodiment, the method may optionally include sending provisioning information to the WTRU(s), wherein the provisioning information comprises at least one of privacy policies, privacy laws, and/or privacy regulations.

In one embodiment, the method may optionally include sending a request for a location of one or more of the WTRUs.

According to an embodiment, the provisioning information may include at least one of privacy policies, privacy laws, and/or privacy regulations that are based on the location of the one or more WTRUs.

In some example embodiments, the determining 510 may include determining, by the NW-side privacy violation engine, whether any one or more of the trained federated learning intermediate model and/or the training data set indicate one or more privacy violations, for example, using a black box approach.

According to an embodiment, the step of determining whether the federated learning model indicates or contains one or more privacy violations, the step of transmitting the message, and the step of receiving trained federated learning models from the WTRUs, may be iteratively performed until a training session for the federated learning intermediate model is complete. For example, the training session may be considered complete after a certain number (e.g., pre-defined) of iterations or when the federated learning model reaches a certain (e.g., pre-defined) performance threshold.

It is noted that FIG. 5 is provided as one example method according to some embodiments. However, the steps depicted in FIG. 5 should not be construed as being mandatory for implementing example embodiments. For example, it should be understood that the method of FIG. 5 may be modified according to, or combined with, other examples or embodiments described elsewhere herein.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, MME, EPC, AMF, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

1. A method implemented in a Wireless Transmit Receive Unit (WTRU), the method comprising:
receiving, from a network entity, a federated learning intermediate model;
training the federated learning intermediate model using a training data set unique to the WTRU to generate a trained federated learning intermediate model;
determining, based on one or more rules associated with a location of the WTRU, whether any one or more of the trained federated learning intermediate model or the training data set indicates one or more privacy violations; and
based on whether any one or more of the trained federated learning intermediate model or the training data set indicates one or more privacy violations, transmitting a message to the network entity.

2. The method of claim 1, wherein:
the determining comprises determining that any one or more of the trained federated learning intermediate model and the training data set do not indicate one or more privacy violations; and
the message comprises the trained federated learning intermediate model.

3. The method of claim 1, wherein:
the determining comprises determining that any one or more of the trained federated learning intermediate model and the training data set indicate one or more privacy violations; and
the message comprises an indication that the trained federated learning intermediate model is rejected.

4. The method of claim 1, wherein the one or more rules associated with the location of the WTRU comprise at least one of privacy policies, privacy laws, or privacy regulations.

5. The method of claim 1, further comprising:
receiving, from the network entity, a request for the location of the WTRU; and
sending the location of the WTRU to the network entity.

6. The method of claim 1, further comprising:
receiving the rules associated with the location of the WTRU from the network entity.

7. The method of claim 1, wherein the determining whether any one or more of the trained federated learning intermediate model and the training data set indicate one or more privacy violations comprises:
transmitting a request to the network entity to perform privacy violation detection on the trained intermediate model, the request comprising an authorization token;
receiving additional information from the network-side privacy violation engine, the additional information comprising at least one of a privacy regulation, a privacy law, an updated privacy policy, or an AIML model; and
determining whether any one or more of the trained federated learning intermediate model and the training data set indicate one or more privacy violations based on the additional information.

8. The method of claim 1, wherein the determining comprises determining, by a client-side privacy violation engine, whether any one or more of the trained federated learning intermediate model and the training data set indicate one or more privacy violations using a white box approach.

9. The method of claim 1, further comprising iteratively performing the receiving, training, determining, and transmitting steps until a training session for the federated learning intermediate model is complete.

10. A wireless transmit/receive unit (WTRU), comprising:
circuitry, including at least one of a transmitter, receiver, processor and memory, configured to:
receive, from a network entity, a federated learning intermediate model;
train the federated learning intermediate model using a training data set unique to the WTRU to generate a trained federated learning intermediate model;
determine based on one or more rules associated with a location of the WTRU, whether any one or more of the trained federated learning intermediate model or the training data set indicates one or more privacy violations; and
based on whether any one or more of the trained federated learning intermediate model or the training data set indicates one or more privacy violations, transmit a message to the network entity.

11. The WTRU of claim 10, wherein:
the determining comprises determining that any one or more of the trained federated learning intermediate model and the training data set do not indicate one or more privacy violations; and
the message comprises the trained federated learning intermediate model.

12. The WTRU of claim 10, wherein:
the determining comprises determining that any one or more of the trained federated learning intermediate model and the training data set indicate one or more privacy violations; and
the message comprises an indication that the trained federated learning intermediate model is rejected.

13. The WTRU of claim 10, wherein the one or more rules associated with the location of the WTRU comprise at least one of privacy policies, privacy laws, or privacy regulations.

14. The WTRU of claim 10, configured to:
receive, from the network entity, a request for the location of the WTRU; and
send the location of the WTRU to the network entity.

15. The WTRU of claim 10, configured to:
receive the rules associated with the location of the WTRU from the network entity.

16. The WTRU of claim 10, wherein to determine whether any one or more of the trained federated learning intermediate model and the training data set indicate one or more privacy violations, the WTRU is configured to:
transmit a request to the network entity to perform privacy violation detection on the trained intermediate model, the request comprising an authorization token;
receive additional information from the network-side privacy violation engine, the additional information comprising at least one of a privacy regulation, a privacy law, an updated privacy policy, or an AIML model; and
determine whether any one or more of the trained federated learning intermediate model and the training data set indicate one or more privacy violations based on the additional information.

17. The WTRU of claim 10, wherein the determining comprises determining, by a client-side privacy violation engine of the WTRU, whether any one or more of the trained federated learning intermediate model and the training data set indicate one or more privacy violations using a white box approach.

18. The WTRU of claim 10, configured to:
iteratively perform the receiving, training, determining, and transmitting steps until a training session for the federated learning intermediate model is complete.

19. (canceled)

20. (canceled)

21. (canceled)

22. (canceled)

23. (canceled)

24. (canceled)

25. (canceled)

26. (canceled)

27. (canceled)

28. A network element, comprising:
circuitry, including at least one of a transmitter, receiver, processor and memory, configured to:
receive a federated learning model from an application server;
determine whether the federated learning model indicates one or more privacy violations; and
based on whether the federated learning model indicates one or more privacy violations, transmit a message to a plurality of WTRUs or to the application server.

29. The network element of claim 28, wherein:
the determining comprises determining that the federated learning model does not indicate one or more privacy violations, and the transmitting comprises transmitting the message comprising the federated learning model to the plurality of WTRUs; or
the determining comprises determining that the federated learning model indicates one or more privacy violations, and the transmitting comprises transmitting to the application server the message comprising an indication that the federated learning model indicates privacy violations.

30. (canceled)

31. (canceled)

32. (canceled)

33. (canceled)

34. (canceled)

35. (canceled)

36. (canceled)
